(19) United States
(12) Patent Application Publication
(10) Pub. No.: US 2026/0189462 A1
(43) Pub. Date: Jul. 2, 2026

(54) COMMUNICATION NETWORK ANALYTICS

(71) Applicant: Telefonaktiebolaget LM Ericsson (publ), Stockholm (SE)

(72) Inventors: Attila Báder, Paty (HU); Gergely Kiss, Budapest (HU); Gábor Magyar, Dunaharaszti (HU)

(21) Appl. No.: 19/131,754

(22) PCT Filed: Nov. 22, 2022
(86) PCT No.: PCT/IB2022/061275

§ 371 Date: May 21, 2025

(51) Int. Cl. H04L 41/14; H04L 43/022; H04L 43/028

(52) U.S. Cl. CPC H04L 41/14; H04L 43/022; H04L 43/028

(57) ABSTRACT

Analytics equipment (14) for a communication network (10) stores a stream (18) of data records (20) from the communication network (10). The analytics equipment (14) samples the stored stream (18T) to obtain a sampled stream (18S) that includes fewer data records (20) than the stored stream (18T). The analytics equipment (14) explores the sampled stream (18S) to identify characteristics (28) of data records (20) to be used for insight creation. Based on the identified characteristics (28), the analytics equipment (14) filters the stored stream (18T) to obtain a filtered stream (18E) that includes data records (20) with the identified characteristics (28). The analytics equipment (14) then creates one or more insights (16) about the communication network (10) using the filtered stream (18E).

### TECHNICAL FIELD

The present application relates generally to a communication network, and relates more particularly to analytics for such a network.

### BACKGROUND

Management of a communication network entails monitoring Key Performance Indicators (KPIs). Although KPIs are suitable for some management tasks, such as detecting node or network failures, KPIs often lack the detail required for effectively creating analytical insights that can help troubleshoot session-based problems and/or identify end-to-end user-perceived service quality issues on an individual, per subscriber level. For this purpose, more advanced analytics approaches collect and correlate elementary network events on a subscriber level in order to achieve a sufficiently high resolution for analytical insight creation.

The plethora of network events in a communication network makes event-based analytics resource intensive, e.g., in terms of the required processing and storage resources, network bandwidth resources, and energy consumption. One known approach to addressing this challenge selectively analyzes only a random sample of reported network events, e.g., events for a random set of subscribers. Another known approach selectively analyzes events that meet certain criteria, such as events for a certain cell. Although these known approaches indeed lower resource demands for event-based analytics, they unacceptably jeopardize the reliability of the resulting analytical insights.

### SUMMARY

Embodiments herein create insight(s) about a communication network using a stream of data records from the communication network, e.g., representing events in the communication network. Embodiments herein store the stream of data records in order to preserve the stream for multiple passes of processing. In a first pass, embodiments herein sample the stored stream and then explore that sampled stream to identify characteristics of data records to be used for insight creation. Next, in a second pass, embodiments herein filter the stored stream based on the identified characteristics and then create insight(s) about the communication network using the resulting filtered stream. Creating insight(s) in this way proves resource efficient yet still reliable.

More particularly, embodiments herein include a method performed by analytics equipment for a communication network. The method comprises storing a stream of data records from the communication network, and sampling the stored stream to obtain a sampled stream that includes fewer data records than the stored stream. The method further comprises exploring the sampled stream to identify characteristics of data records to be used for insight creation. The method also comprises, based on the identified characteristics, filtering the stored stream to obtain a filtered stream that includes data records with the identified characteristics. The method then comprises creating one or more insights about the communication network using the filtered stream.

In some embodiments, each data record is a record of data from an event in the communication network, and storing the stream of data records comprises receiving records of data from respective events as those events occur and storing the received records of data. In some embodiments, sampling the stored stream comprises, for each of one or more types of events in the communication network, sampling data records in the stored stream that are from that type of event at a sampling rate defined for the type of event.

In some embodiments, each data record in the stored stream is a record of data for a subscriber to the communication network. In one such embodiment, sampling the stored stream comprises sampling the stored stream across all subscribers to the communication network.

In some embodiments, filtering the stored stream based on the identified characteristics comprises generating filtering decision logic configured to separate data records with the identified characteristics from data records without the identified characteristics. In some embodiments, filtering the stored stream based on the identified characteristics comprises filtering the stored stream according to the filtering decision logic to obtain the filtered stream that includes data records with the identified characteristics and excludes data records without the identified characteristics.

In some embodiments, said exploring comprises exploring the sampled stream to identify characteristics of data records that provide insight into a problem in the communication network.

In some embodiments, said exploring comprises exploring the sampled stream to identify that a data record to be used for insight creation is characterized by having one or more certain values for one or more respective data fields in the data record. In some embodiments, the identified characteristics are the one or more certain values for the one or more respective data fields. In some embodiments, the one or more respective data fields include a subscriber field indicating an identity or type of a subscriber. In other embodiments, the one or more respective data fields alternatively or additionally include a device field indicating an identity or type of a communication device. In yet other embodiments, the one or more respective data fields alternatively or additionally include a cell field indicating an identity or type of a cell.

In some embodiments, filtering the stored stream comprises retrieving the stored stream from storage of the analytics equipment and filtering the retrieved stream based on the identified characteristics without first sampling the retrieved stream. Alternatively or additionally, creating the one or more insights about the communication network using the filtered stream may comprise creating the one or more insights about the communication network using the filtered stream without first sampling the filtered stream.

In some embodiments, storing comprises storing the stream of data records in a message bus, a data lake, or a database.

In some embodiments, storing, sampling, exploring, filtering, and creating is performed iteratively over multiple iterations. In one such embodiment, the method further comprises determining a reliability of the one or more insights created using the filtered stream in a certain iteration, and adapting a rate at which the stored stream is to be sampled in a subsequent iteration, based on the determined reliability.

In some embodiments, each data record is a cell traffic record.

In some embodiments, the one or more insights include an insight into a problem in the communication network, and the method further comprises providing the insight into the problem to remediation equipment configured to remediate the problem using the insight into the problem.

Other embodiments herein include analytics equipment for a communication network. The analytics equipment is configured to store a stream of data records from the communication network. The analytics equipment is also configured to sample the stored stream to obtain a sampled stream that includes fewer data records than the stored stream. The analytics equipment is also configured to explore the sampled stream to identify characteristics of data records to be used for insight creation. The analytics equipment is also configured to, based on the identified characteristics, filter the stored stream to obtain a filtered stream that includes data records with the identified characteristics. The analytics equipment is also configured to create one or more insights about the communication network using the filtered stream.

In some embodiments, the analytics equipment is configured to perform the steps described above for analytics equipment.

In some embodiments, computer program comprising instructions which, when executed by at least one processor of analytics equipment, causes the analytics equipment to perform the steps described above for analytics equipment. In some embodiments, a carrier containing the computer program is one of an electronic signal, optical signal, radio signal, or computer readable storage medium.

Other embodiments herein include analytics equipment. The analytics equipment comprises data stream storage configured to store a stream of data records from the communication network, and processing circuitry. The processing circuitry is configured to store a stream of data records from the communication network. The processing circuitry is also configured to sample the stored stream to obtain a sampled stream that includes fewer data records than the stored stream. The processing circuitry is also configured to explore the sampled stream to identify characteristics of data records to be used for insight creation. The processing circuitry is also configured to, based on the identified characteristics, filter the stored stream to obtain a filtered stream that includes data records with the identified characteristics. The processing circuitry is also configured to create one or more insights about the communication network using the filtered stream.

In some embodiments, the processing circuitry is configured to perform the steps described above for analytics equipment.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of analytics equipment for a communication network according to some embodiments.

FIG. 2A is a block diagram of an example of sampled stream exploration according to some embodiments.

FIG. 2B is a block diagram of an example of sampled stream exploration targeting handover failure events according to some embodiments.

FIG. 3 is a block diagram of analytics equipment for a communication network according to other embodiments.

FIG. 4 is a logic flow diagram of a method performed by analytics equipment for a communication network according to some embodiments.

FIG. 5 is a block diagram of analytics equipment for a communication network according some embodiments.

FIG. 6 shows an example of a communication system in accordance with some embodiments.

FIG. 7 is a block diagram of a host which may be an embodiment of the host of FIG. 6, in accordance with various aspects described herein.

### DETAILED DESCRIPTION

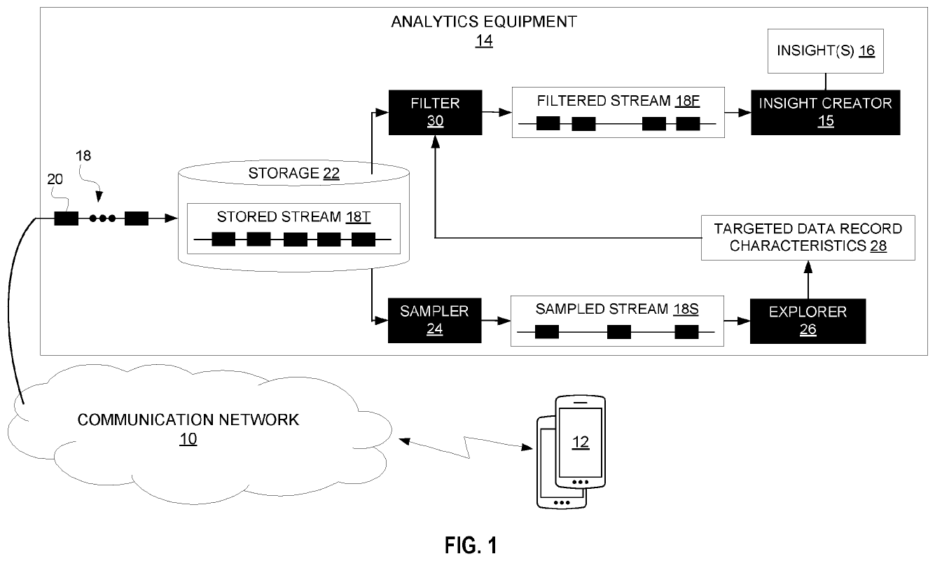

FIG. 1 shows a communication network 10 according to some embodiments, e.g., a 5G network. The communication network 10 provides communication service to one or more communication devices 12, e.g., in the form of user equipments (UEs) 12. The communication network 10 may do so on the basis of respective subscription(s) that the communication device(s) 12 have to receive communication service from the communication network 10.

FIG. 1 further shows analytics equipment 14 for the communication network 10. The analytics equipment 14 may be a part of the communication network 10, or may be external to the communication network 10. Regardless, the analytics equipment 14 includes an insight creator 15 configured to create one or more insights 16 about the communication network 10, e.g., including an insight into a problem in the communication network 10. The insight(s) 16 may for example include (i) metric(s) indicating service quality of a mobile broadband service, e.g. video, streaming (Netflix, Youtube, etc.) or video conferencing (Teams, Meet); (ii) identification of cell(s) or area(s) with radio issues (bad coverage, coverage holes, interference, handover problems); (iii) identification of badly performing cell(s) for a specific service, e.g. voice, cloud gaming, etc. ; (iv) identification of overloaded core network node(s), or function(s), affecting service quality; and/or (v) identification of bad terminal type(s), operating system software version(s) having frequent connection setup issues with new 5G radio (possibly only in an area where radio is provided by a specific vendor). Regardless, in one or more of these embodiments where the insight(s) 16 include an insight into a problem, the analytics equipment 14 may provide the insight to remediation equipment (not shown) for remediating the problem using the insight into the problem.

With regard to insight creation, though, the analytics equipment 14 generally creates the insight(s) 16 using a stream 18 of data records 20 from the communication network 10. In one specific example, each data record 20 is, or includes data from, a cell traffic record (CTR). In some embodiments, the analytics equipment 14 continuously receives data records 20 in the stream 18 as those data records 20 are generated or reported by the communication network 10, i.e., in real time. In these and other embodiments, the data records 20 in the stream 20 may be ordered according to the chronological order in which the data records 20 were generated or reported by the communication network 10.

In one example, each data record 20 is a record of data from an event in the communication network 10, e.g., where such data may include a type of the event, a time of the event, a communication device 12 or subscriber associated with the event, etc. An event in the communication network 10 may for instance be registration of a communication device 12 with the communication network 10, termination of a communication device's session, handover of a communication device 12 between radio network nodes, or any other occurrence that characterizes what is happening in the communication network 10. As another example, key performance indicators (KPIs) may be reported as events as such or as attributes of one or more events, such as session initiation time, a ratio of unsuccessful session initiations, the amount of transmitted bytes over a given amount of time, etc. KPIs in this regard may be calculated from or attributed to one or multiple events. Regardless, in the case where each data record 20 is a record of data from an event in the communication network 10, the stream 18 of data records 20 may effectively represent a stream of events in the communication network 10, for supporting event-based analytics. The analytics equipment 14 in fact may receive records of data from respective events as those events occurs in the communication network 10, i.e., in real time. In these and other embodiments, the data records 20 in the stream 20 may be ordered to reflect the chronological order of events represented by the data records 20. An event in this regard may be reported when it is locally detected by a network node in the communication network 10 or in response to probing.

As an example, a handover failure can be reported in an event. Exemplary KPIs calculated from this or these events either locally in the communication network 10 or centrally in a network management domain are a number of handover failures or a ratio of the handover failures and the total handovers in a time period. As another example, a user plane probe may report a throughput event every 5 seconds in a dedicated event report. An average throughput KPI can be calculated locally or centrally as the average of these throughputs for 1 minute, and a maximum throughput KPI can be calculated locally or centrally as the maximum of the reported throughputs in 1 minute.

No matter the particular nature of the data records 20 in the stream 18, though, the data records 20 in the stream 18 in some embodiments are reported by the communication network 10 with a volume or resolution high enough to support creation of the insight(s) 16 at a required granularity and/or with a required level of reliability. The data records 20 in the stream 18 may for instance include records of data from events associated with all subscribers in the communication network 10 and/or all cells in the communication network 10, e.g., so as to avoid excluding data records that would provide insight into a problem experienced by certain subscribers and/or experienced in certain cells. In some embodiments, then, the stream 18 contains a very large number of data records 20. The analytics equipment 14 in these and other embodiments herein advantageously processes the stream 18 of data records 20 in a way that is sensitive to the resources required to create insight(s) 18 from such a stream 18, yet protective of the reliability of those insight(s) 18.

FIG. 1 in particular shows that the analytics equipment 14 stores the stream 18 of data records 20 from the communication network 10, at least on a temporary basis. So stored, the stream 18 of data records 20 is referred to as the stored stream 18T of data records 20. The analytics equipment 14 as shown for example stores the stream 18 of data records 20 (as stored stream 18T) in a storage 22, e.g., which may take the form of a message bus, a data lake, or a database. By storing the stream 18 of data records 20 in this way, the analytics equipment 14 advantageously preserves the stored stream 18T for being processed according to embodiments herein. For example, the analytics equipment 14 in some sense processes the stored stream 18T over multiple passes of processing. Understood in this way, even after processing the stored stream 18T in one pass of processing, storage of the stored stream 18T enables the analytics equipment 14 to preserve an unprocessed version of the stored stream 18T for re-processing in another pass.

More particularly in this regard, the analytics equipment 14 in FIG. 1 includes a sampler 24. The sampler 24 samples the stored stream 18T to obtain a sampled stream 18S that includes fewer data records 20 than the stored stream 18T. The sampler 24 may for example sample the stored stream 18T at a sampling rate (e.g., 1/3), so as to select only a defined ratio of data records 20 from the stored stream 18T (e.g., 1 out of every 3 data records) for inclusion in the sampled stream 18S. In one embodiment, the sampler 24 may do so without discriminating between different data records 20, e.g., in terms of the types of events represented by the data records 20. In another example, though, the sampler 24 samples the stored stream 18T on an event type by event type basis. In one such embodiment, for each of one or more types of events in the communication network 10, the sampler 24 samples data records in the stored stream 18T that are from that type of event at a sampling rate defined for the type of event, e.g., 1/5 for data records from registration events, 1/2 for data records from handover events, etc. Regardless, sampling the stored stream 18T of data records 20 effectively prunes the stored stream 18T of data records 20, e.g., as needed to reduce the resources required to further process the data records 20.

Notably, though, in some embodiments, the sampler 24 samples the stored stream 18T of data records 20 indiscriminately, so as to reduce the number of the data records 20 in the stream 20 without skewing or biasing underlying characteristics of the resulting sampled stream 18S. The sampled stream 18S thereby includes the same format and content as the stored stream 18T, just with fewer data records 20. For example, in one embodiment where each data record 20 is a record of data for a subscriber to the communication network 10, the sampler 24 may sample the stored stream 18T across all subscribers to the communication network 10, i.e., so as not to discriminate between different subscribers. In another example, where each data record 20 is associated with a cell in the communication network 10, the sampler 24 may sample the stored stream 18T across all cells in the communication network 10, i.e., so as not to discriminate between different cells. In either case, sampling the stored stream 18T in this way advantageously reduces the number of data records 20 to be processed while still preserving any underlying characteristics in the stored stream 18T that would have been lost had the stored stream 18T been filtered to exclude data records 20 associated with certain subscriber(s) and/or certain cell(s).

Furthermore, the sampler 24 notably samples the stored stream 18T in a way that is non-destructive to the stored stream 18T. That is, even after the sampler 24 samples the stored stream 18T to obtain the sampled stream 18S, the stored stream 18T remains unaltered in the storage 22 so as to preserve an unprocessed version of the stored stream 18T.

In any event, with the sampled stream 18S obtained, the analytics equipment 14 explores the sampled stream 18S to identify characteristics of data records 20 to be used for insight creation. The analytics equipment 14 as shown in this regard includes explorer 26 for this purpose. The explorer 26 in some embodiments explores the sampled stream 18S in the sense that the explorer 26 inspects, evaluates, or otherwise analyzes the data records 20 in the sampled stream 18, e.g., according to one or more rules, thresholds, or machine learning models. Such exploration reveals characteristics of data records 20 to be used for insight creation. These characteristics are thereby appropriately shown in FIG. 1 as targeted data record characteristics 28, in the sense that the characteristics 28 are characteristics of data records targeted for use in insight creation.

Consider an example. In some embodiments, the explorer 26 analyzes the sampled stream 18S for evidence of one or more potential problems in the communication network 10. As a simplistic example, the explorer 26 analyzes the sampled stream 18S for evidence of potential handover problems in the communication network 10, and deduces that handover to a certain cell is potentially problematic if the data records 20 in the sampled stream 18S indicate that the rate of handover failure for the cell is greater than a threshold rate. As another example, the explorer 26 analyzes the sampled stream 18S for evidence of potential call drop problems for a certain type of communication device 12, and deduces that dropped calls for a certain type of communication device 12 is potentially problematic if the data records 20 in the sampled stream 18S indicate that the call drop rate for the certain type of communication device 12 is above a threshold call drop rate. As yet another example, the explorer 26 analyzes the sampled stream 18S for evidence of potential service quality issues, and deduces that service quality problems potentially exist for a certain type of service if the data records 20 in the sampled stream 18S indicate that the certain type of service has meaningfully more issues compared to other types of services. No matter the type of the potential problem(s), the explorer 26 in this case identifies characteristics of data records 20 that provide insight into the potential problem(s), e.g., insight into whether there is in fact a problem and/or insight into the root cause of the problem. For example, data records 20 that provide insight into a potential problem with handover to a certain cell have the characteristic of being associated with (e.g., reported for) that certain cell. Data records 20 that provide insight into a potential problem with dropped calls for a certain type of communication device 12 have the characteristic of being associated with (e.g., reported for) that certain type of communication device 12. Generally, then, the explorer 26 in these embodiments explores the sampled stream 18S to identify characteristics of data records 20 that provide insight into actual or potential problem(s) in the communication network 10.

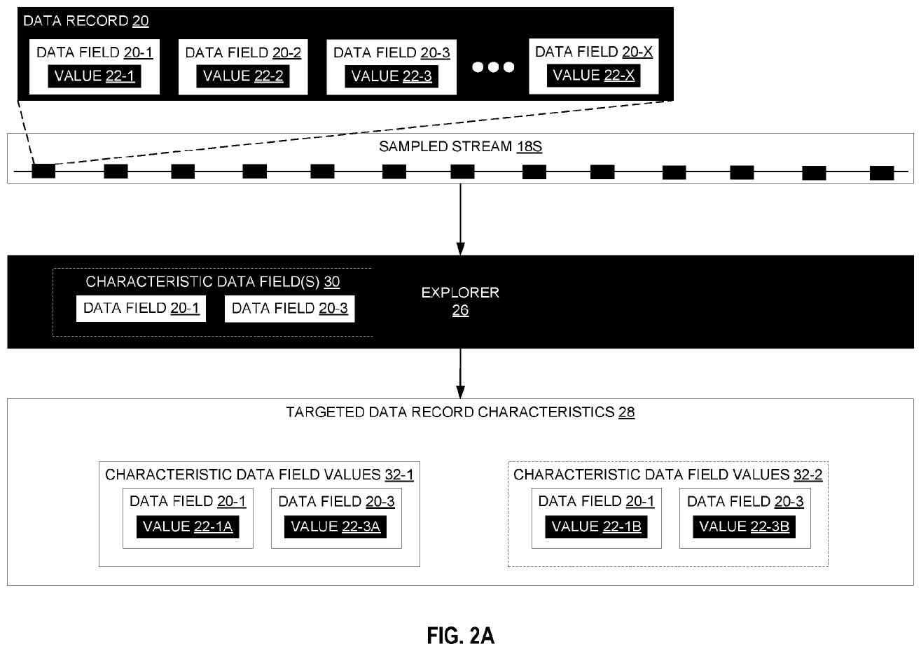

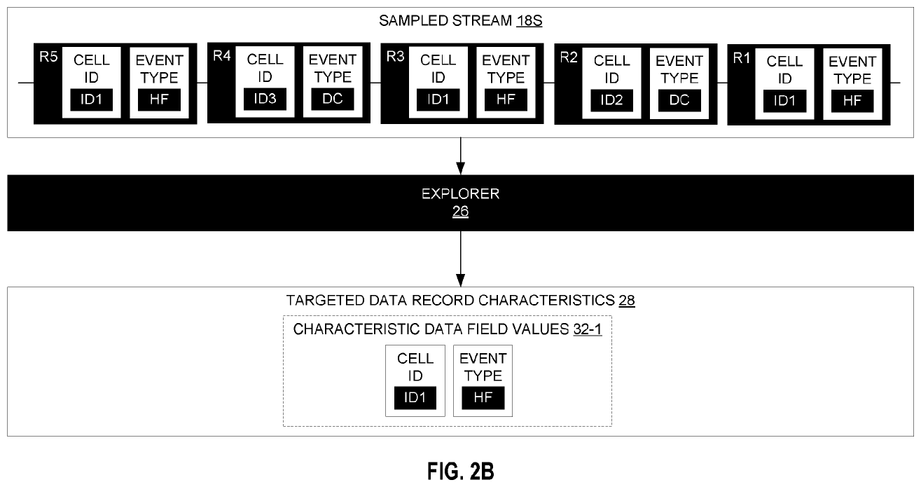

Generally, though, FIGS. 2A-2B illustrate additional details for sampled stream exploration in embodiments where each data record 20 in the stored stream 18S includes one or more data fields 20-1 . . . 20-X, X≥1. As shown in FIG. 2A, a data record 20 has value 22-1 for data field 20-1, value 22-2 for data field 20-2, value 22-3 for data field 20-3, and so on until value 22-X for data field 20-X. Effectively, then, each data record 20 is a record of respective value(s) 22-1 . . . 22-X for data field(s) 20-1 . . . 20-X. In this case, the explorer 26 explores the sampled stream 18S by analyzing the value(s) 22-1 . . . 22-X for at least some of the data field(s) 20-1 . . . 20-X in each data record 20. The explorer in particular explores the sampled stream 18S to identify that a data record to be used for insight creation is characterized by having one or more certain values for one or more respective data fields in the data record.

As an example, FIG. 2A shows the explorer 26 identifies that a data record to be used for insight creation is characterized by having certain values for data fields 20-1 and 20-3, referred to for convenience as the characteristic data field(s) 30. In particular, the explorer 26 identifies that a data record to be used for insight creation is characterized by having value 22-1A for data field 20-1 and value 22-3A for data field 20-3. Any data record that has value 22-1A for data field 20-1 and value 22-3A for data field 20-3 is accordingly to be used for insight creation, and any data record that does not have value 22-1A for data field 20-1 and value 22-3A for data field 20-3 is not to be used for insight creation, e.g., in favor of reducing the number of data records to be analyzed. The values 22-1A, 22-3A for data fields 20-1, 20-3 in this case constitute the targeted data record characteristics 28 because they characterize data records to be used for insight creation.

As shown, though, the explorer 26 in some embodiments may identify multiple possibilities for the values of the data fields 20-1, 20-3 that can characterize a data record to be used for insight creation. In such a case, then, the explorer 26 may identify that a data record to be used for insight creation is characterized by either (i) having value 22-1A for data field 20-1 and value 22-3A for data field 20-3; or (ii) having value 22-1B for data field 20-1 and value 22-3B for data field 20-3. Of course, although exemplified with two possibilities, the explorer 26 may identify any number of possibilities for characterizing data records 20 to use for insight creation.

As a particularly applicable example, the data field(s) whose values characterize data records to be used for insight creation may include (i) a cell field indicating an identity or type of a cell; (ii) a device field indicating an identity or type of a communication device 12; and/or (iii) a subscriber field indicating an identity or type of a subscriber.

FIG. 2B illustrates a simple example for identifying characteristics of data records to be used for creating an insight into a problem with handover to a particular cell. In this example, the sampled stream 18S includes data records R1-R5 that are each a record of data from an event in the communication network 10. Each data record includes a cell ID field indicating an identity of a cell for which an event is reported and an event type field indicating a type of the event reported. Record R1 is shown in this example as being a record of data from a handover failure (HF) event for cell ID1, record R2 is a record of data from a dropped call (DC) event in cell ID2, record R3 is a record of data from another handover failure (HF) event in cell ID1, record R4 is a record of data from a dropped call (DC) event in cell ID3, and record R5 is a record of data from yet another handover failure (HF) event in cell ID1. In one embodiment, the explorer 26 explores these data records R1-R5 and identifies cell ID1 and event type HF as being characteristic of data records to be used for creation of an insight into a potential problem with handover failure. In particular, the explorer 26 identifies that data records to be used for creation of an insight into a potential problem with handover failure are characterized by having cell ID1 as the value of the cell ID field and HF as the value of the event type field. In another embodiment not shown, though, the explorer 26 may identify just cell ID1 as being characteristic of data records to be used for creation of an insight into a potential problem with handover failure, so as to more broadly characterize data records to be used for insight creation as encompassing all data records for cell ID1, not just data records for cell ID1 that report a handover failure event.

As a general proposition, then, the explorer 26 in some embodiments is somewhat over-inclusive in characterizing data records 20 to be used for insight creation, so as to err on the side of causing more data records 20 than perhaps strictly necessary to be used for insight creation. The explorer 26 may do so to reduce the chance of undesirably excluding data records 20 that would meaningfully contribute to insight reliability, albeit at the expense of a marginal increase in the number of data records 20 that must be analyzed.

Notably, exploration herein proves practical from a resource demand perspective because the exploration is performed on a stream 18S that is sampled, as opposed to being performed on a stream that is not sampled. Indeed, exploration need only be performed on a number of data records 20 that is meaningfully reduced as compared to the number of data records 20 in the (unsampled) stored stream 18T. Meanwhile, exploration in some embodiments herein proves particularly effective from an insight reliability perspective because the exploration is performed on a stream that is unfiltered, as opposed to being performed on a stream that is filtered so as to bias or skew the underlying characteristics of the stream.

Yet, because of the sampling by sampler 24, the sampled stream 18S lacks the resolution or granularity needed to create certain types of insights, e.g., full data record visibility may be needed for creating deep insights on a subscriber level. Towards this end, having identified the characteristics 28 of the data records 20 to target for insight creation, the analytics equipment 14 back in FIG. 1 uses those characteristics 28 to re-process the stored stream 18T, e.g., in a subsequent pass of processing. This is where preservation of the stored stream 18T in storage 22, unaffected by sampling and exploration, proves useful, since the stored stream 18T has not been sampled by sampler 24 and thereby has the requisite resolution or granularity. Indeed, the stored stream 18T was preserved in unprocessed form so that the analytics equipment 14 could re-process the stored stream 18T in another pass, but this time with the advantage of knowing characteristics 28 of data records 20 useful for insight creation.

The analytics equipment 14 in this regard is notably configured to filter 30 the stored stream 18T (not the sampled stream 18S) based on those characteristics 28. Towards this end, FIG. 1 shows that the analytics equipment 14 includes a filter 30 configured to receive the targeted data record characteristics 28 as filtering criteria based on which to filter 30 the stored stream 18T. The filter 30 may for example generate filtering decision logic configured to separate data records with the characteristics 28 from data records without the characteristics 28, and then filter the stored stream 18T according to this filtering decision logic. In these and other embodiments, the filter 30 may retrieve the stored stream 18T from storage 22 and filter the retrieved stream based on the targeted data record characteristics 28 without first sampling the retrieved stream. by filtering the stored stream 18T based on the targeted data record characteristics 28, the filter 30 obtains a filtered stream 18F that includes data records 20 with the targeted data record characteristics 28, e.g., to the exclusion of data records 20 without those characteristics 28. It is this filtered stream 18F, as opposed to the stored stream 18T or the sampled stream 18S, that the insight creator 15 actually uses to create the insight(s) 16. Indeed, in some embodiments, the insight creator 15 creates the insight(s) 16 using the filtered stream 18F without first sampling that filtered stream 18F.

Notably, insight creation herein proves practical from a resource demand perspective because the insight creation is performed on a stream 18F that is filtered, as opposed to being performed on a stream that is not filtered. Indeed, insight creation need only be performed on a number of data records 20 that is meaningfully reduced as compared to the number of data records 20 in the (unsampled and unfiltered) stored stream 18T. Meanwhile, insight creation in some embodiments herein proves particularly effective from an insight reliability perspective because the insight creation is performed on a stream 18F that, though filtered, is intelligently filtered to selectively include data records 20 that will meaningfully contribute to insight creation.

In the context of the handover issue example, the explorer 26 evaluates handover events in the sampled stream 18S to identify cell(s) in which handover is potentially problematic. The explorer 26 targets one or more cell identities as the targeted data record characteristics 28 based on which the filter 30 is to filter the stored stream 18T. The filter 30 correspondingly filters the stored stream 18T so that the filtered stream 18F only includes data records 20 for the one or more cell identities targeted for insight creation. This way, rather than having to evaluate data records 20 for all cells, the insight creator 15 need only evaluate data records 20 for a subset of the cell(s). In some embodiments, for example, the insight creator 15 evaluates Radio Resource Control (RRC) radio reports for the one or more cell identities targeted, in an attempt to identify a root cause of the handover issue for each cell. Such RRC radio reports are resource-intensive to report and evaluate, so limiting such reports for only a subset of cells proves advantageous from a resource efficiency perspective.

In the context of the service quality example, the sampler 24 samples the stored stream 18T so that the sampled stream 18S includes data records 20 representing heavy user plane probe events for only 10% of subscribers. Based on this limited number of data records 20, the explorer 26 observes that one service type has more frequent service quality issues as compared to the other service types. The explorer 26 therefore defines the targeted data record characteristics 28 as being the potentially problematic service type, so that the filtered stream 18F will include data records 20 for only that potentially problematic service type. This way, 100% of user plane and other events are represented in the filtered stream 18F for the potentially problematic service type. Based on this full monitoring for the service type, the insight creator 15 can identify the root cause of the service quality issue and all affected subscribers. If for example the root cause is a software version of a terminal type, these subscribers can be contacted and the software version can be refreshed in their terminals, which solves the network-wide issue. In this use case, it is not needed to monitor the user plane for all subscribers, which would be too resource-intensive.

Nonetheless, given the stream nature of the data records 20, some embodiments herein iteratively adapt sampling and/or filtering as needed to meet one or more objectives, e.g., concerning resource efficiency and/or insight reliability. For example, in some embodiments, the analytics equipment 14 performs a post-creation evaluation of the reliability of the insight(s) 16 created in a given iteration, and adapts the rate(s) at which the sampler 24 is to sample the stored stream 18T in a subsequent iteration, based on that reliability. In one such embodiment, the analytics equipment 14 increases the sampling rate if insight reliability falls below a first threshold, in an effort to improve insight reliability by analyzing more data records 20. The analytics equipment 14 on the other hand may decrease the sampling rate if insight reliability rises above a second threshold, in an effort to improve resource efficiency by decreasing the number of data records 20 analyzed.

Similarly, note that in some embodiments due to the stream nature of the data records 20 the stored stream 18T filtered by the filter 30 may not be identical to the stored stream 18T sampled by the sampler 24. For example, in some embodiments, data records 20 may continue to accumulate in storage 22 in the interim during analysis by the explorer 26, so that the stored stream 18T eventually filtered by the filter 30 includes more and/or different data records 20 than those sampled by the sampler.

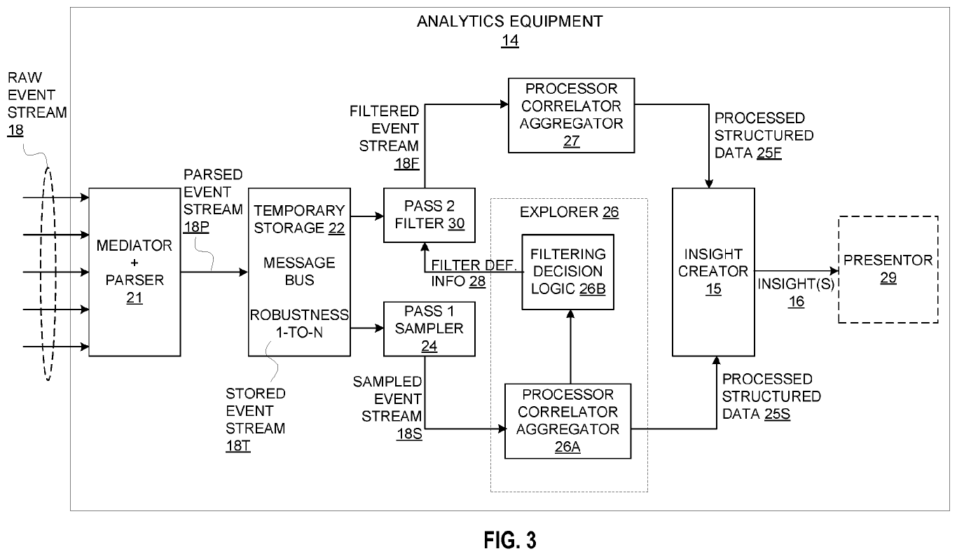

FIG. 3 shows additional details of some embodiments herein where the stream 18 is or includes an event stream, with data records in the event stream corresponding to respective events in the communication network 10. These embodiments are exemplified by referring to sampling as pass 1 of processing the event stream, and to filtering as pass 2 of processing the event stream. Pass 1 (sampling) in this example aims to identify characteristics 28 of data records 20 to be used for insight creation, with those characteristics 28 in this example taking the form of so-called network segments. Network segments in this case are a set of values for a set of dimensions, e.g., a specific cell, or a specific communication device 12 in a specific cell. More particularly, the analytics equipment 14 correlates many type of events from multiple data sources, network nodes, and/or subscriber or cell reference data. These events contain many parameters, which characterize a given session. These parameters can be user-specific (e.g., subscription plan, user group, etc.) terminal-specific (e.g., vendor, device type, android or IOS), service-specific (e.g., Application IDs of the actually used services), or cell-specific (e.g., the actual serving cell ID used, frequency, radio access technology type, etc.). The correlated records include many KPIs. These KPIs can be derived, obtained separately for certain values of the above parameters. Some embodiments herein refer to the characterizing parameters as dimensions and refer to the KPIs being derived to these dimensions, e.g., setup failure rate is obtained separately for different services, or for different cells. This is the way to identify if there is any problem related to any parameter (in any dimension), or parameter values.

Pass 2 (filtering) filters the event stream to include data records for the network segments identified in Pass 1, for further analysis of those data records, e.g., to check if problems actually exist in those network segments (or are expected to exist soon).

More particularly, Pass 1 in this example aims to process the stream 18 from the perspective of the whole communication network 10, so as not to discriminate between different segments of the communication network 10. Pass 1 also aims to process an amount of data that is as low as possible. Yet Pass 1 furthermore aims to effectively create reliable high-level insights (e.g., KPIs) that will enable the analytics equipment 14 to identify target data record characteristics 26, e.g., in the form of network segments where further deep analysis is needed.

As shown in FIG. 3, the stream 18 received by the analytics equipment 14 is actually a raw event stream, i.e., a stream of raw events reported by the communication network 10. Events may arrive from one or more data sources, one or more domains (e.g., core and radio) and/or from different network functions (NFs) (e.g., signaling and user plane functions).

The analytics equipment 14 in this example includes a mediator+parser 21 that operates to condition the raw event stream 18 for handling by the analytics equipment 14, e.g., to process different event and data formats from different data sources into a common format that can be processed by the analytics equipment 14. With such conditioning, the mediator+parser 21 produces a parsed event stream 18P. The mediator+parser 21 may for example parse events in the stream to extract useful/required information of the events and transform that information to an internal event format. The analytics equipment 14 then stores this parsed event stream 18P in storage 22 as stored event stream 18T.

The storage 22 is shown for example as a temporary storage in the form of a message bus, e.g., Kafka with robustness 1-to-N. In other embodiments not shown, though, the storage 22 may take the form of a data lake, a local storage, or a network management system. Regardless, as a general matter, the storage 22 in this example may be configured so that it is possible to retrieve data records from the storage 22 based on a network segment definition-which in this case translates to filtering based on a whitelist of values for some dimensions. Note that the above filtered retrieval might contain additional non-matching values, but the overall amount of data records shall be relatively low. That is, for example, it might be enough to be able to provide cell-level filtering from the storage 22 and use that filtering also for any more restrictive segments (like a given communication device type in that cell). In such cases, the next processing element shall drop additional data.

Regardless, in the message bus implementation shown, the above is achievable based on data partitioning. In an implementation based on a traditional database, the storage 22 may allow indexing and filtering, e.g., based on SQL. In an implementation based on a local storage connected to specific network segments-ranging from radio equipment to core network sites, the storage 22 may be partitioned by default and may use the other solutions for further partitioning. This way, based on support from the network elements, even collection of data might be restricted to the amount which gets processed.

Storing the event stream 18T ensures that each event is reliably transported and not lost. In some embodiments, the events are tagged with a correlation key, like IMSI, IP address or tunnel endpoint ID (TEID), and timestamp.

For the first pass of processing the stored event stream 18T, the analytics equipment 14 includes pass 1 sampler 24 that performs event-based sampling, to obtain a sampled event stream 18S. This means that, for each event type, pass 1 sampler 24 samples the stored event stream 18T at a sampling rate specific for that event type, e.g., where there may be a number of event types for control plane, user plane, performance monitoring, etc. The event type specific sampling rate might even be 0% for some of types of events, e.g., some low-level events might not be needed for the first high-level analysis.

In fact, in some embodiments, pass 1 sampler 24 performs even lower level sampling, on an intra-record basis, to effectively filter out some data fields in data records 20 for specific events, e.g., where the filtered data fields would have a high processing cost and their processing may only be needed for deep analysis in pass 2. As the aim with this first pass is only to identify characteristics 28 of data records 20 to be processed in pass 2, such low-level information might be skipped for pass 1.

For comparison purposes, sampling based on subscriber identity (e.g., International Mobile Subscription Identifier, IMSI, based sampling) would risk having network segments with no data at all, or even if there is some data, the statistical deviation could be very high, such the insights would not be reliable. This is because for small network segments, like cells, usually only some tens of subscribers are active simultaneously; thus, applying a 10% sampling would mean collecting data records from an average amount of 2-5 subscribers per cell. Even if a good way of sampling were to be found, that small number of subscribers is typically not at all representative for the whole population, and the choice of subscribers would give a high uncertainty about the results.

This problem with other known approaches would be even more visible upon the addition of other dimensions, like the type of communication device or access to a specific service. When concerned with subscribers of a specific type of communication device in each cell, IMSI-based sampling would likely just get rid of most of the relevant subscribers and just not provide results at all for most locations.

Event-based sampling overcomes these challenges. When performing sampling on the event level, the analytics equipment 14 in some embodiments keeps all existing connections between locations, communication devices, service providers and so on. Moreover, samples from multiple subscribers have a much smaller deviation so it makes the resulting insights more reliable. For example, when checking throughput figures from say ten subscribers, getting 1/10^{th} of the throughput figures from each subscriber gives a much better estimate for the network traffic than getting the full traffic data from a single subscriber, as in the latter case that subscriber might be one who generates much more or much less traffic than other subscribers for a specific reason.

In any event, the sampled event stream 18S in FIG. 3 in some embodiments carries the same format and content as it did in the baseline, just the amount of data is decreased dramatically. Some embodiments even define sampling rates based on statistical deviation observed on the data. For example, the analytics equipment 14 in some embodiments keeps more data records for processing (i.e., higher sampling rate) in case of network segments having results that are not that reliable, and keeps less data records for processing (i.e., lower sampling rate) where even less would be enough to provide reliable results.

Of course, there is a drawback with event sampling: the sampled data records do not make it possible to fully follow even a single subscriber's behavior, which makes it very hard to provide deep analysis of any observed problems. For example, determining the root cause of handover-related problems or call drops usually requires full visibility of the related events. This level of detail is not available in the proposed first pass. It is the next pass through selected data records that provides those insights.

Towards this end, FIG. 3 shows the explorer 26 from FIG. 1 in the form of a processor/correlator/aggregator 26A in combination with filtering decision logic 26B. Based on the sampled event stream 18S, the processor/correlator/aggregator 26A in combination with filtering decision logic 26B determines a list of network segments where further analytics is needed to check if problems exist (or are expected to exist soon). Filtering decision logic 26B in this regard returns a list of such network segments as the target data record characteristics, referred to in FIG. 3 as the filtering definition information 28

The list of network segments can be determined either based on a single correlated record, or aggregated information. The list of network segments can accordingly be determined from subscriber or network incidents based on a rule, anomaly detection using KPI trend analysis, or exceptional values related to a network parameter. In other embodiments, the list of network segments can be determined based on drilling down KPIs to different parameters: e.g., video quality KPIs per cell, terminal type, core network nodes, or radio environment parameters such as reference signal received power (RSRP) and/or reference signal received quality (RSRQ). In yet other embodiments, the list of network segments can be determined by running machine learning models for the different sets of parameters.

In some embodiments, then, the processor/correlator/aggregator 26A uses a correlation key to sort events into correlated records, containing all information from different network domains (core, radio, etc.) belonging to a single session. The processor/correlator/aggregator 26A may alternatively or additionally calculate KPIs based on information reported in the event fields. Correlated events can then use the same key, e.g., IMSI. In some embodiments, these KPIs are aggregated by different network, subscriber, or service parameters and for different time intervals. Network parameters can be location (cell, area, etc.), network node or node functions, e.g. User Plane Function (UPF), Session Management Function (SMF), Access and Mobility Function (AMF), Radio Access Type (RAT) or connection type (4G, 5G, fixed access, etc.). Subscriber parameters are like subscription groups, pre-or postpaid subscription. Service parameters are service types: like web, video, voice, or service provider, etc.

The filtering decision logic 26B itself can be based any of the following non-limiting examples: rule-based decision logic, covariance analysis, fixed threshold monitoring on KPIs or aggregate values, adaptive threshold monitoring (based on machine learning) on KPIs or aggregate values, or other machine learning models.

Reliability of the sampled event stream 18S can be estimated by statistical means, for example, based on standard deviation. Reliability metrics may be used to adjust sampling in order to lower sampling rates while still keeping reliable results. Even non-reliable results might be taken as a base for the decision logic-however, this would either mean false positives, that is, network segments that are analyzed later thoroughly however there are no problems with them (meaning higher processing cost) or false negatives (missing problematic network segments, for example, due to processing capacity constraints).

In any event, rather than the network segments resulting from the filtering decision logic 26B being the end result of analysis, the network segments are instead further used as input for Pass 2. Accordingly, instead of having to be restrictive enough so that an end user can check the resulting list without being lost in an overwhelming stream of false positives, the filtering decision logic 26B in this case can safely include false positives to an extent based on processing cost. That is, rules, thresholds and machine learning models in some embodiments may allow for more matches, effectively making the probability of catching a given problem higher.

For the second pass through the stored event stream 18T, the Pass 2 filter 30 receives as input the network segments that are output from the filtering decision logic 26B in the form of filtering definition information 28. The Pass 2 filter 30 filters the stored event stream 18T based on this filtering definition information 28, to obtain the filtered event stream 18F. The number of data records 20 resulting in the filtered event stream 18F in some embodiments is at least an order of magnitude less than the number of data records 20 in the stored event stream 18T. This makes it possible to decrease TCO dramatically.

FIG. 3 shows that, in some embodiments, processor/correlator/aggregator 27 processes the filtered data stream 18F to produce processed structured data 25F. Insight creator 15 receives this processed structured data 25F and creates insight(s) 16 therefrom. Notably, the decreased number of data records in the filtered event stream 18F, as compared to the stored event stream 18T, allows for more precise analytics, since the filtered event stream 18F can contain more samples than would be possible without filtering.

In some embodiments, the analytics equipment 14 as shown provides the insight(s) 16 to a presenter 29, to present the insight(s) 16 for use. Such presentation may take the form of communication to other equipment (not shown), e.g., machine actors for supporting closed-loop actions. Or, presentation may take the form of outputting the insight(s) 16 for display, e.g., on a graphical user interface (GUI) or dashboard for action to be taken by network engineers.

Some embodiments herein are applicable for Customer Experience Management (CEM) or Subscriber Analytics systems, which are part of the Network Management domain, for monitoring and analyzing service and network quality on the subscriber level in mobile networks. CEM systems are used in Network Operation Centers (NOC) and Service Operation Centers (SOC) and by Network Optimization Engineering (Network Performance Management).

Embodiments herein are additionally or alternatively applicable in the 5G core network on the 3GPP standard level (e.g., 3GPP 23.288). The analytics equipment 14 in this case may take the form of a core network element that implements the network data analytics function (NWDAF), which provides analytics for operator personnel and/or for closed-loop actions driven by network nodes.

Some embodiments herein are applicable for generating insight(s) 16 from network Key Performance Indicators (KPIs). The KPIs are based on node and network events and counters. KPIs are aggregated in time and often for node or other dimensions, e.g. device type, service provider, etc. KPIs can indicate node or network failures but usually they are not detailed enough for troubleshooting, and they are not suitable for identifying end-to-end, user-perceived service quality issues. Embodiments herein accordingly perform troubleshooting by further investigating these KPIs in conjunction with the event stream collected from different network nodes and domains.

Some embodiments for example are applicable for advanced analytics systems, such as the Ericsson Expert Analytics (EEA), based on collecting and correlating elementary network events as well as end-to-end (e2e) service quality metrics and computing user level e2e KPIs based on the available data. Embodiments in this case may be suitable for session-based troubleshooting and/or analysis of network issues.

Some embodiments correspondingly perform real-time collection and correlation of characteristic node and protocol events from different radio and core nodes, probing signaling IFs and/or sampling of the user-plane traffic. Beside the data collection and correlation functions, the analytics equipment 14 in some embodiments exploits an advanced database, rule engine, and/or big data analytics platform.

Some embodiments herein accordingly accommodate for networks generating an enormous number of events. With the spread of 5G technology, this amount is expected to increase dramatically. Some embodiments thereby accommodate monitoring, processing, and storing all these events in a way that reduces the total cost of ownership (TCO) of the analytics equipment 14.

Some embodiments do so in a way that avoids skipping some areas from the analytics, for example, by concentrating on different network segments one after the other, in a round-robin fashion. This avoids the scenario where all network segments would be out of the monitoring scope most of the time. Some embodiments thereby monitor the whole network continuously, so as to reliably find more than just static or regularly occurring problems.

Some embodiments furthermore do so in a way that avoids simply sampling based on subscription identifiers, so as to analyze some of the user base and skip others. Some embodiments accordingly account for the reality that the distribution of IMSIs over network segments is pretty much uneven, and for smaller segments, the chosen set would not be not representative. Some embodiments are thereby capable of addressing smaller scopes, like single cells, or users of a specific device in a given cell, or even more specific segments, for example, those using a specific video provider from the above users.

Some embodiments herein are furthermore capable of supporting multiple use cases efficiently, e.g., multiple network dimensions, while still remaining resource efficient.

Generally, some embodiments enable a low-cost network monitoring and analytics system. Instead of processing the enormous size full input data stream, some embodiments process a cleverly sampled input data stream at first, to evaluate the critical network segments that need deep inspection. Then, at the second step, when the critical network segments have been identified, the analytics equipment 14 turns back to the original input data stream lying in the temporary storage, and processes only the filtered input data for the critical network segments. By this, the analytics equipment 14 achieves a significant footprint reduction without much harm on the quality of the results.

The analytics equipment 14 accordingly in some embodiments represents a two-pass, real-time data processing framework. In pass 1, data exploration is done to find problematic segments and to provide a high level view of the communication network 10. This data exploration is performed on sampled input data only to achieve a low-cost solution. The analytics equipment 14 in some embodiments applies event-based sampling in pass 1 for increased robustness, instead of the traditional IMSI-based sampling, e.g., on the user plane events. In pass 2, the detailed analysis of the problematic network segments is performed based on the learnings of pass 1. In this analytic phase, the full input data is used but it is filtered only for the problematic network segments identified in pass 1.

Certain embodiments may provide one or more of the following technical advantage(s). Firstly, some embodiments enable processing only a small fraction of all incoming data in depth without losing major functionality. The first, high level pass over available data makes it possible to choose where to focus detailed analysis. Shortly, some embodiments enable a major footprint reduction in the network analytics system while keeping full network visibility.

Secondly, event sampling-instead of the traditional ID-based (e.g., IMSI) sampling introduces robustness into the system. For many use cases, for example, throughput related ones, statistical deviation can be decreased, effectively allowing for well-founded insights for smaller granularity of network segments, thus supporting the correction of more specific problems.

Thirdly, there is no need for specific filtering, sampling functionality at data sources, which are many times 3^{rd} party equipment. Some embodiments support multiple use cases in an efficient way.

Consider now an example scenario.

### Magnitude of Footprint Reduction

In this example, the analytics equipment 14 has two main data sources: user plane (UP) (events received from User Plane Functions, UPFs) and control plane (CP) (received from control plane network function, e.g., AMF, SMF). The unfiltered, not sampled data load from UP is 200 Gbps, while the CP load is 1.5 Gbps in an average network, requiring 1200 vCPUs for data processing.

By 30% consistent random IMSI sampling at the data sources, which is a state of the art footprint reduction solution, the event load can be decreased both at UP and CP to 30%, which reduces the required vCPUs to about 500. In this scenario most of the use cases can be supported. In case of small number of samples for CP KPIs can be solved by aggregating data for larger time periods (3 times more), so the drawback can be the worse time resolution of CP KPIs. Furthermore, smaller issues, which require 100% data, are not detected.

By using embodiments herein, the UP data load can be reduced to 10% while the CP load can be reduced to 30%. It results in a total data load of slightly more than 10%. The required total number of vCPUs is 300. By selecting the required events and event sampling rate for monitoring appropriately, there will not be hidden issues comparing to the full data solution. Problematic node or network instances are investigated in full details based on the 2^{nd} pass data.

In summary, the hardware footprint using some embodiments herein can be reduced approximately to ¼ of the full data without affecting the analytics use cases.

### Example of Insight Creation

Analytics insights creation is explained by an example:

The analytics equipment 14 in some embodiment is collecting and correlating events from core network CP and UP NFs, e.g. SMF, AMF, UPF. In addition to this, the analytics equipment 14 may obtain radio signaling and radio environment reports event data, namely CTR, of eNBs and gNBs.

In Pass 1, the following events are monitored and sampling rates are applied:
UP:
   TCP report: 0%
   UDP report: 20%
CP:
   Registration: 10%
   Session setup: 30%
   Session modification: 10%
   Session termination: 100%
Radio:
   Handover events: 30%
   Radio Access Bearer (RAB) setup, management and termination Radio Resource Control (RRC) events: 30%
   Radio environment meas. report: 30%

Based on these data the following KPIs are obtained and monitored.
Throughput, bitrate, round trip time (RTT) for sensitive UDP transported traffic types, based on UDP reports.
Less sensitive TCP traffic are not monitored in order to decrease load.
Abnormal session termination number and ratio based on session termination (critical indicator for operation, 100% monitoring)
Session setup number and success ratio (less important indicator, 30% monitoring)
Registration, session modification related KPIs are just monitored at high level (e.g., to obtain typical value)
Handover success/failure number and ratio based on handover radio events (less critical indicator, 30% monitoring)
RAB setup, modification and termination number and ratio based on RRC events
RSRP, RSRQ, SINR, Uplink power based on RRC meas. reports.

These KPIs are obtained for different network and node dimensions, such as cell, NFs, terminal types, etc.

These network and node instances are ranked for the above KPIs and the underperforming cells, NFs, etc. are identified.

For example, cells where throughput is significantly low, or handover failure ration is significantly higher than the average, or drop rate is higher. Or UPF node where the throughput is low.

In Pass 2 all events are positively filtered for the underperforming network and node instance.

These additional data are used for
identifying further issues; and/or
identify root cause

For example, in a badly performing cell based on UPT throughput, the TCP events are also obtained and service quality, e.g., mobile broadband (MBB) video quality is also obtained based on TCP reports.

By monitoring 100% of radio data for these cells in Pass 2, the root cause of the issue is also identified: bad RSRP and uplink power indicate coverage issue, low RSRQ indicates high interference. High handover failure ratio associated with high drop rate in relation to a neighbor cell indicates a handover issue.

In case of e.g., high RTT in relation to a UPF node, the full UP reports are obtained in Pass 2 for the given UPF. Based on this information, the suboptimal transport route or bad gateway address is identified.

In summary, in pass 1 the network is monitored by about 10-20% of the event load. Using an additional 10% of the total events, the badly performing network or node instances are analyzed in full detail.

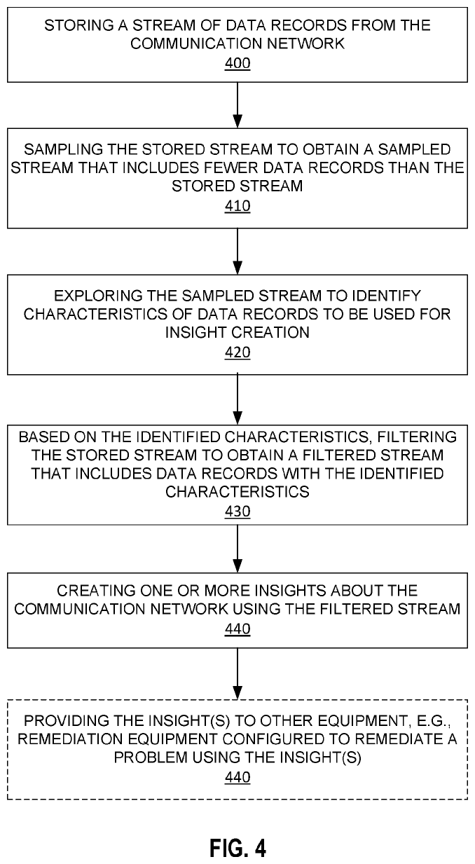

In view of the modifications and variations herein, FIG. 4 depicts a method performed by analytics equipment 14 for a communication network 10 in accordance with particular embodiments. The method includes storing a stream 18 of data records 20 from the communication network 10 (Block 400). The method also includes sampling the stored stream 18T to obtain a sampled stream 18S that includes fewer data records 20 than the stored stream 18T (Block 410). The method further includes exploring the sampled stream 18S to identify characteristics 28 of data records 20 to be used for insight creation (Block 420). The method also includes, based on the identified characteristics 28, filtering the stored stream 18T to obtain a filtered stream 18F that includes data records 20 with the identified characteristics 28 (Block 430). The method then includes creating one or more insights 16 about the communication network 10 using the filtered stream 18F (Block 440).

In some embodiments, the method also comprises providing the insight(s) 16 to other equipment (Block 440). For example, where the insight(s) 16 include an insight into a problem, the method may comprise proving the insight to remediation equipment configured to use the insight into the problem in order to remediate the problem.

In some embodiments, each data record 20 is a record of data from an event in the communication network 10. In one such embodiment, storing the stream 18 of data records 20 may comprise receiving records of data from respective events as those events occur and storing the received records of data. In some embodiments, sampling the stored stream 18T comprises, for each of one or more types of events in the communication network 10, sampling data records 20 in the stored stream 18T that are from that type of event at a sampling rate defined for the type of event.

In some embodiments, each data record 20 in the stored stream 18T is a record of data for a subscriber to the communication network 10. In one such embodiment, sampling the stored stream 18T comprises sampling the stored stream 18T across all subscribers to the communication network 10.

In some embodiments, filtering the stored stream 18T based on the identified characteristics 28 comprises generating filtering decision logic configured to separate data records with the identified characteristics 28 from data records without the identified characteristics 28. In some embodiments, filtering the stored stream 18T based on the identified characteristics 28 comprises filtering the stored stream 18T according to the filtering decision logic to obtain the filtered stream 18F that includes data records 20 with the identified characteristics 28 and excludes data records 20 without the identified characteristics 28.

In some embodiments, said exploring comprises exploring the sampled stream 18S to identify characteristics 28 of data records 20 that provide insight into a problem in the communication network 10.

In some embodiments, said exploring comprises exploring the sampled stream 18S to identify that a data record to be used for insight creation is characterized by having one or more certain values for one or more respective data fields in the data record. In some embodiments, the identified characteristics 28 are the one or more certain values for the one or more respective data fields. In some embodiments, the one or more respective data fields include a subscriber field indicating an identity or type of a subscriber. In other embodiments, the one or more respective data fields alternatively or additionally include a device field indicating an identity or type of a communication device. In yet other embodiments, the one or more respective data fields alternatively or additionally include a cell field indicating an identity or type of a cell.

In some embodiments, filtering the stored stream 18T comprises retrieving the stored stream 18T from storage of the analytics equipment 14 and filtering the retrieved stream based on the identified characteristics 28 without first sampling the retrieved stream. Alternatively or additionally, creating the one or more insights 16 about the communication network 10 using the filtered stream 18F may comprise creating the one or more insights 16 about the communication network 10 using the filtered stream 18F without first sampling the filtered stream 18F.

In some embodiments, storing comprises storing the stream 18 of data records 20 in a message bus, a data lake, or a database.

In some embodiments, storing, sampling, exploring, filtering, and creating is performed iteratively over multiple iterations. In one such embodiment, the method further comprises determining a reliability of the one or more insights 16 created using the filtered stream 18F in a certain iteration, and adapting a rate at which the stored stream 18T is to be sampled in a subsequent iteration, based on the determined reliability.

In some embodiments, each data record 20 is a cell traffic record.

In some embodiments, the one or more insights 16 include an insight into a problem in the communication network 10, and the method further comprises providing the insight into the problem to remediation equipment configured to remediate the problem using the insight into the problem.

Embodiments herein also include corresponding apparatuses. Embodiments herein for instance include analytics equipment 14 configured to perform any of the steps of any of the embodiments described above for the analytics equipment 14.

Embodiments also include analytics equipment 14 comprising processing circuitry and power supply circuitry. The processing circuitry is configured to perform any of the steps of any of the embodiments described above for the analytics equipment 14. The power supply circuitry is configured to supply power to the analytics equipment 14.

Embodiments further include analytics equipment 14 comprising processing circuitry. The processing circuitry is configured to perform any of the steps of any of the embodiments described above for the analytics equipment 14. In some embodiments, the analytics equipment 14 further comprises communication circuitry.

Embodiments further include analytics equipment 14 comprising processing circuitry and memory. The memory contains instructions executable by the processing circuitry whereby the analytics equipment 14 is configured to perform any of the steps of any of the embodiments described above for the analytics equipment 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

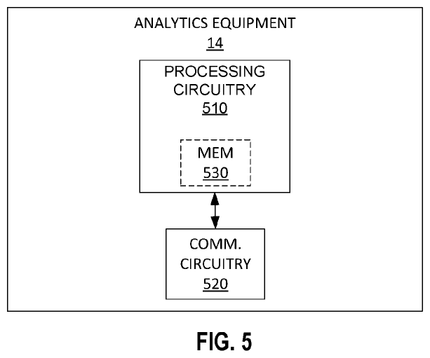

FIG. 5 for example illustrates analytics equipment 14 as implemented in accordance with one or more embodiments. As shown, the analytics equipment 14 includes processing circuitry 510 and communication circuitry 520. The communication circuitry 520 is configured to transmit and/or receive information to and/or from one or more other nodes, e.g., via any communication technology. Such communication may be for receiving the stream 18 of data records 20. The processing circuitry 510 is configured to perform processing described above, e.g., in FIG. 4, such as by executing instructions stored in memory 530. The processing circuitry 510 in this regard may implement certain functional means, units, or modules.

Those skilled in the art will also appreciate that embodiments herein further include corresponding computer programs.

A computer program comprises instructions which, when executed on at least one processor of analytics equipment 14, cause the analytics equipment 14 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of analytics equipment 14, cause the analytics equipment 14 to perform as described above.

Embodiments further include a computer program product comprising program code portions for performing the steps of any of the embodiments herein when the computer program product is executed by analytics equipment 14. This computer program product may be stored on a computer readable recording medium.

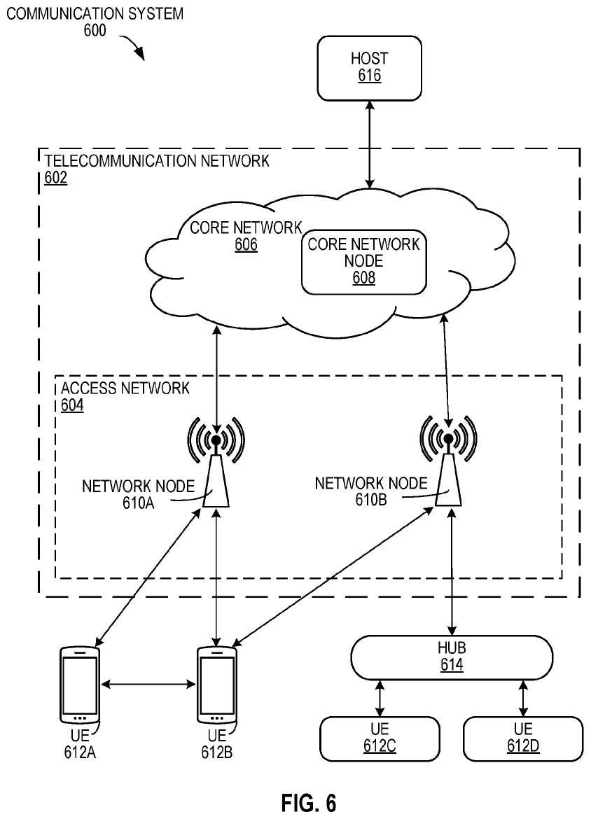

FIG. 6 shows a communication system 600 as an example implementation of the communication network 10 for which the analytics equipment 14 may perform analytics.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub-that is, a hub whose primary function is to route communications to/from the UEs from/to the network node 610b. In other embodiments, the hub 614 may be a non-dedicated hub-that is, a device which is capable of operating to route communications between the UEs and network node 610b, but which is additionally capable of operating as a communication start and/or end point for certain data channels.

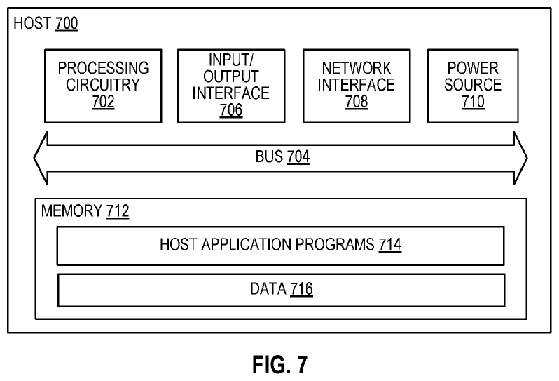

FIG. 7 is a block diagram of a host 700, which may be an embodiment of the host 616 of FIG. 6, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIG. 7 and QQ3, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

1.-19. (canceled)

20. A method performed by analytics equipment for a communication network, the method comprising:
storing a stream of data records from the communication network;
sampling the stored stream to obtain a sampled stream that includes fewer data records than the stored stream;
exploring the sampled stream to identify characteristics of data records to be used for insight creation;
based on the identified characteristics, filtering the stored stream to obtain a filtered stream that includes data records with the identified characteristics; and
creating one or more insights about the communication network using the filtered stream.

21. The method of claim 20, wherein each data record is a record of data from an event in the communication network, and wherein storing the stream of data records comprises receiving records of data from respective events as those events occur and storing the received records of data.

22. The method of claim 21, wherein sampling the stored stream comprises, for each of one or more types of events in the communication network, sampling data records in the stored stream that are from that type of event at a sampling rate defined for the type of event.

23. The method of claim 20, wherein each data record in the stored stream is a record of data for a subscriber to the communication network, and wherein sampling the stored stream comprises sampling the stored stream across all subscribers to the communication network.

24. The method of claim 20, wherein filtering the stored stream based on the identified characteristics comprises:
generating filtering decision logic configured to separate data records with the identified characteristics from data records without the identified characteristics; and
filtering the stored stream according to the filtering decision logic to obtain the filtered stream that includes data records with the identified characteristics and excludes data records without the identified characteristics.

25. The method of claim 20, wherein said exploring comprises exploring the sampled stream to identify that a data record to be used for insight creation is characterized by having one or more certain values for one or more respective data fields in the data record, wherein the identified characteristics are the one or more certain values for the one or more respective data fields.

26. The method of claim 25, wherein the one or more respective data fields include:
a subscriber field indicating an identity or type of a subscriber; and/or
a device field indicating an identity or type of a communication device; and/or
a cell field indicating an identity or type of a cell.

27. The method of claim 20, wherein filtering the stored stream comprises retrieving the stored stream from storage of the analytics equipment and filtering the retrieved stream based on the identified characteristics without first sampling the retrieved stream, and wherein creating the one or more insights about the communication network using the filtered stream comprises creating the one or more insights about the communication network using the filtered stream without first sampling the filtered stream.

28. The method of claim 20, wherein said storing, sampling, exploring, filtering, and creating is performed iteratively over multiple iterations, and wherein the method further comprises:
determining a reliability of the one or more insights created using the filtered stream in a certain iteration; and
adapting a rate at which the stored stream is to be sampled in a subsequent iteration, based on the determined reliability.

29. The method of claim 20, wherein the one or more insights include an insight into a problem in the communication network, and wherein the method further comprises providing the insight into the problem to remediation equipment configured to remediate the problem using the insight into the problem.

30. Analytics equipment for a communication network, the analytics equipment comprising:
data stream storage configured to store a stream of data records from the communication network; and
processing circuitry configured to:
store a stream of data records from the communication network;
sample the stored stream to obtain a sampled stream that includes fewer data records than the stored stream;
explore the sampled stream to identify characteristics of data records to be used for insight creation;
based on the identified characteristics, filter the stored stream to obtain a filtered stream that includes data records with the identified characteristics; and
create one or more insights about the communication network using the filtered stream.

31. The analytics equipment of claim 30, wherein each data record is a record of data from an event in the communication network, and wherein the processing circuitry is configured to receive records of data from respective events as those events occur and store the received records of data.

32. The analytics equipment of claim 31, wherein the processing circuitry is configured to, for each of one or more types of events in the communication network, sample data records in the stored stream that are from that type of event at a sampling rate defined for the type of event.

33. The analytics equipment of claim 30, wherein each data record in the stored stream is a record of data for a subscriber to the communication network, and wherein the processing circuitry is configured to sample the stored stream across all subscribers to the communication network.

34. The analytics equipment of claim 30, wherein the processing circuitry is configured to:
generate filtering decision logic configured to separate data records with the identified characteristics from data records without the identified characteristics; and
filter the stored stream according to the filtering decision logic to obtain the filtered stream that includes data records with the identified characteristics and excludes data records without the identified characteristics.

35. The analytics equipment of claim 30, wherein the processing circuitry is configured to explore the sampled stream to identify that a data record to be used for insight creation is characterized by having one or more certain values for one or more respective data fields in the data record, wherein the identified characteristics are the one or more certain values for the one or more respective data fields.

36. The analytics equipment of claim 35, wherein the one or more respective data fields include:
a subscriber field indicating an identity or type of a subscriber; and/or
a device field indicating an identity or type of a communication device; and/or
a cell field indicating an identity or type of a cell.

37. The analytics equipment of claim 30, wherein the processing circuitry is configured to retrieve the stored stream from storage of the analytics equipment and filter the retrieved stream based on the identified characteristics without first sampling the retrieved stream, and to create the one or more insights about the communication network using the filtered stream without first sampling the filtered stream.

38. The analytics equipment of claim 30, wherein the processing circuitry is configured to perform said storing, sampling, exploring, filtering, and creating iteratively over multiple iterations, and is further configured to:
determine a reliability of the one or more insights created using the filtered stream in a certain iteration; and
adapt a rate at which the stored stream is to be sampled in a subsequent iteration, based on the determined reliability.

39. The analytics equipment of claim 30, wherein the one or more insights include an insight into a problem in the communication network, and wherein the processing circuitry is further configured to provide the insight into the problem to remediation equipment configured to remediate the problem using the insight into the problem.
